(19) United States
(12) Patent Application Publication
(10) Pub. No.: US 2007/0206577 A1
(43) Pub. Date: Sep. 6, 2007

(54) Personalized call setup media exchange in packet and circuit switched networks

(76) Inventor: James D. Bennett, San Clemente, CA (US)

Correspondence Address: GARLICK HARRISON & MARKISON, P.O. BOX 160727, AUSTIN, TX, 78716-0727, US

(21) Appl. No.: 11/365,451

(22) Filed: Mar. 1, 2006

(51) Int. Cl. H04L 12/66

(52) U.S. Cl. 370/356

(57) ABSTRACT

A telephony infrastructure, consisting of Internet and public switched telephone networks, support servers and a plurality of telephony devices, supports personalized pre and post call media exchanges. Prior to detecting a pick-up event, a recipient device and a calling device display tailored announcement media and tailored reply media, respectively. Tailoring of announcement media singles out one of a plurality of users of a one receiving device. After the pick-up event, supplemental post-connection media and real-time voice information are exchanged. The announcement, reply, and supplemental post-connection media can be any combination of real-time or pre-defined audio, video, and text. Such media in whole or in part may be exchanged between the devices, retrieved from support servers, and retrieved from local storage. Either device may employ media override capabilities.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

1. Field of the Invention

This invention generally relates to voice communication systems.

2. Related Art

A typical telephone network in use today consists of public switched telephone network telephony devices attached to public switched telephone networks and Internet telephony devices attached to Internet networks. Internet telephony devices are gaining widespread acceptance today. Internet voice communication utilizes computers and Internet connections to make calls to remote locations. Internet telephony devices include a personal or laptop computer, a headset, and microphone or stand alone Internet phones. Typically, Internet phones allow the users to make calls to a remote desktop, cordless or cell phone. A public switched telephone network telephony device uses a desktop or cordless telephone to make calls to a remote terminal. Further, cell phones utilize cellular networks and public switched telephone network to make calls to distant remote terminals.

As a part of call setup, today's Internet phones and public switched telephone network phones may display a caller's Voice over Internet Protocol (VoIP) handle or telephone number on the display of the receiving phone together with a ring tone sequence. Further, the calling Internet phone also displays Voice over Internet Protocol (VoIP) handle or telephone number on the display of the calling phone together with a ring tone sequence to indicate the occurrence of ring tone sequence at the receiving phone's end. Current cellular phones support video images of the caller in the receiving phones, ring tone selection that identifies the caller and post connection media such as an exchange of captured images. Today's Internet phones support file exchanges.

Often, in a typical household or office setting, a single telephone connection or a single Internet telephony connection is shared by a plurality of users. When a single telephone or a single Internet telephony connection is shared by a plurality of users, the users are often confused as to whom the call is addressed. Everyone rushes to take the call only to find that the call is intended for another.

Similarly, a plurality of telephone numbers and Internet telephony identification addresses are associated with each user, such as one for home, some for office and one more while being mobile. In this situation, a caller may find it hard to know which of the telephone numbers and Internet telephony identification addresses to call to reach the user. In other situations, the caller is often unaware of what is happening when there is no response from any of the phones associated with the user.

Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the Claims.

In accordance with the present invention, a telephone network that supports personalized announcements in a shared VoIP network. The telephone network consists of an Internet network, a public switched telephone network, support servers, and a plurality of client telephony devices that support one or both of Internet network and public switched telephone network. For example, consider client telephony devices such as a first receiving telephony device that supports both a first user and second user and a second receiving telephony device that supports the first user. Further, consider a first calling telephony device that attempts to establish a first Internet call to the first user and second calling telephony device that attempts to establish a second Internet call to the second user. All of these telephony devices are communicatively coupled to the Internet network. Both the first receiving and second receiving telephony devices respond to the first calling telephony device's attempts to establish the first Internet call to the first user. The first receiving telephony device responds by generating an announcement targeting the first user and the first receiving telephony device responds to the attempt to establish the second Internet call by generating an announcement targeting the second user. Further, consider a third calling telephony device attempts to establish a voice call to the second user via the public switched telephone network by identifying the first user as part of the attempt to establish the voice call. The first receiving telephony device and the second receiving telephony device both respond to the attempt by playing an announcement targeting the first user. The telephone network consists of databases and application software distributed between support servers and client devices, they store, process and keep records of announcement media and user lists.

Circuitry of a typical client telephony device consists of Internet interfaces, device to user interfaces, processing circuitry, media interfaces, and memory. The processing circuitry responds to the call setup request received from the Internet via the Internet interface circuit by identifying one of the plurality of users, constructing an announcement targeting the identified one of the plurality of users and delivering the announcement to the device to user interface circuit.

Features and advantages of the present invention will become apparent from the following detailed description of the invention made with reference to the accompanying drawings.

### BRIEF DESCRIPTION OF THE DRAWINGS

FIG. 1 is a schematic block diagram of a voice communication infrastructure, built in accordance with the present invention, illustrating a plurality of telephony devices that provide personalized announcements over Internet;

FIG. 2 is a block diagram illustrating personalized message, greetings, announcement and post connection media flow between an initiating client device and a multi-user recipient client device, in a voice communication infrastructure, in accordance with the present invention;

FIG. 3 is a schematic diagram illustrating an embodiment of encapsulation for an announcement media packet 305, in accordance with the present invention;

FIG. 4 is a block diagram illustrating a client device constructed in accordance with the embodiment of FIG. 1 of the present invention;

FIG. 5 is a block diagram illustrating a client device constructed in accordance with the embodiment of FIG. 1 of the present invention, with a multi-user support;

FIG. 6 is a block diagram illustrating database operations performed by access management software applications, located either centrally at a support server or in a distributed manner in the support server and the clients, in a voice communication infrastructure with a plurality of client devices, in accordance with the present invention;

FIG. 7 is a schematic diagram illustrating the process of personalized announcement media exchanges between a calling telephony device and a receiving telephony device, in accordance with the present invention;

FIG. 8 is a flow diagram illustrating the method performed by a receiving telephony device during a voice communication set up with a calling telephony device;

FIG. 9 is a flow diagram illustrating the method performed by a receiving telephony device when a call set up request is received from a calling telephony device;

FIG. 10 is a flow diagram illustrating the method performed by a calling telephony device during a call set up with one of the users of a receiving telephony device shared by a plurality of users;

FIG. 11 is a flow diagram illustrating the method involved in personalized message, greetings, announcement and post connection media exchange between an initiating client device and a multi-user recipient client device, in accordance with the present invention; and

FIG. 12 is a block diagram illustrating a client device constructed in accordance with the embodiment of FIG. 1 of the present invention, with details of external storage media.

### DETAILED DESCRIPTION OF THE INVENTION

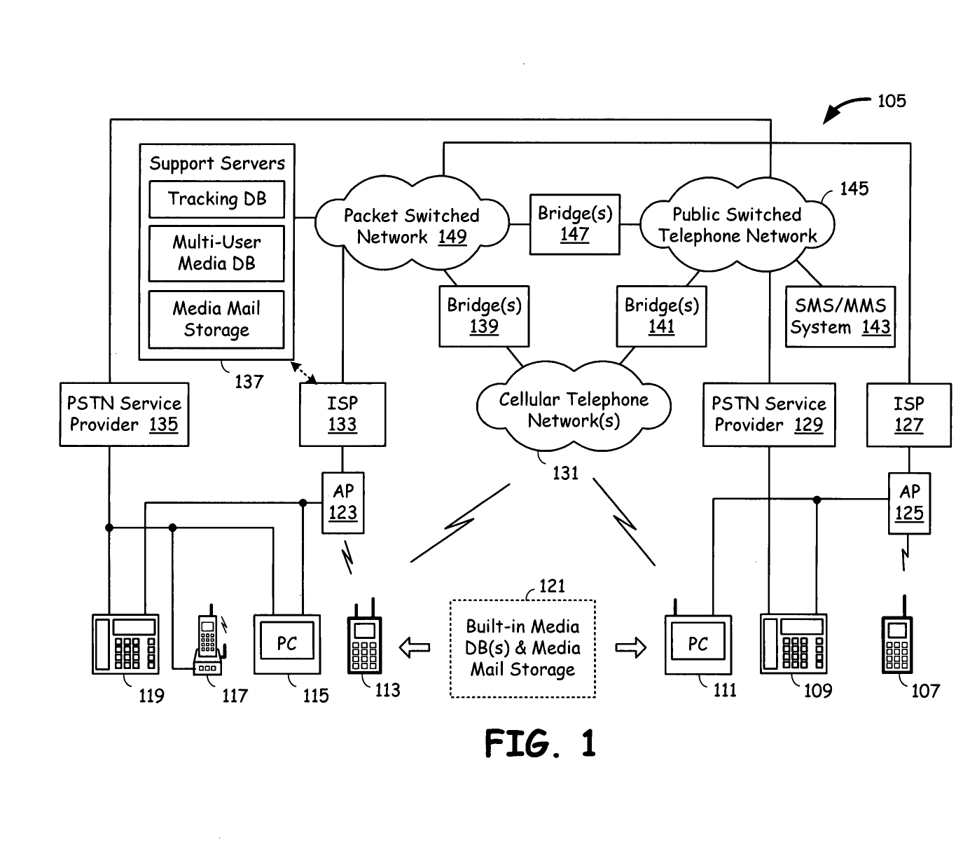

FIG. 1 is a schematic block diagram of a voice communication infrastructure 105, built in accordance with the present invention, illustrating a plurality of telephony devices that provide personalized announcements over Internet, in accordance with the present invention. In the voice communication infrastructure 105, the schematic block diagram illustrates a packet switched network 149 communicatively coupled to Internet Service Provider (ISP) 127 and 133. The schematic diagram also illustrates a public switched telephone network 145 communicatively coupled to Public Switched Telephone Network (PSTN) service providers 129 and 135. Further illustrated is cellular telephone network(s) 131 that are communicatively coupled to a plurality of devices with voice communication and/or Internet functionality such as a cellular device 113 and personal (laptop) computer 111. The networks 131, 145 and 149 are communicatively coupled via bridge(s) such as 139, 141, and 147. A Short Message Service/Media Message Service (SMS/MMS) system 143 is communicatively coupled to the public switched telephone network 145.

Access points 125 and 123 allow internet service providers 127 and 133 to communicatively couple to a plurality of devices with voice communication and/or Internet functionality such as a cellular device 113, personal computers 111 and 11 5, wireless voice communication device 107 and desktop voice communication devices 109 and 119. The voice communication devices 109 and 119 have dual functionality in that they communicatively couple with both PSTN service providers such as 129 and 135 and Internet service providers such as 127 and 133 and communicate using either or both of packet switched and public switched telephone networks. A cordless voice communication device 117 is communicatively coupled to the PSTN service provider 135. The personal computer 115 is also communicatively coupled to the PSTN service provider 135.

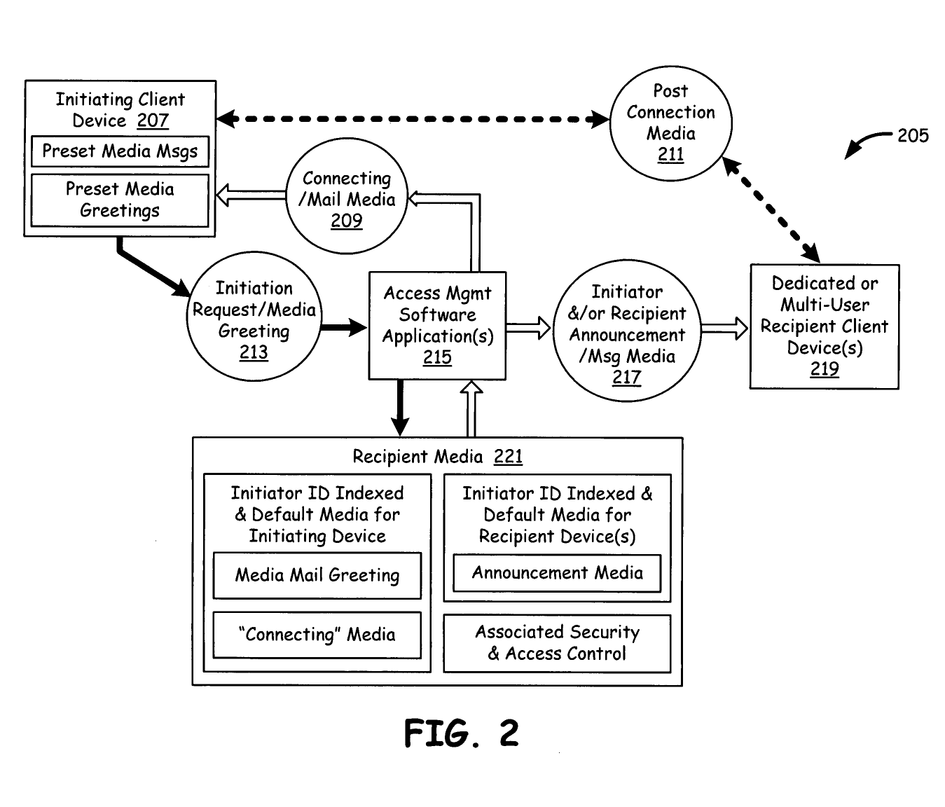

Each of the voice communication devices 107, 109, 111, 113, 115, 117 or 119 built according to the present invention incorporates built-in media databases (DB) and media mail storage 121. Further, support server 137 are incorporated in to the packet switched network 149 or Internet service provider 133, which further contain tracking databases, multi-user media databases and media mail storage. The functions of built-in media databases (DB) and media mail storage 121 and support server 137 are described in detail through out the specifications and in specific with reference to FIGS. 2, 4, 5, 6 and 12.

The call model, according to the present invention, is centered on personalized or tailored announcement media (announcement media, hereafter) that are directed to a recipient user, initiated by a caller before setting up a call with the user and video and text messages during the call. The calling user also receives announcements before the call and post connection messages immediately after the pickup as a response from the recipient user. The announcement media may consist of live, preset, or recorded audio/video clips and text messages. A caller initiates the announcement media before a call is set up with a recipient user and the announcement media may originate from the calling telephony device 107, 109, 111, 113, 115, 117, or 119, or support server 137.

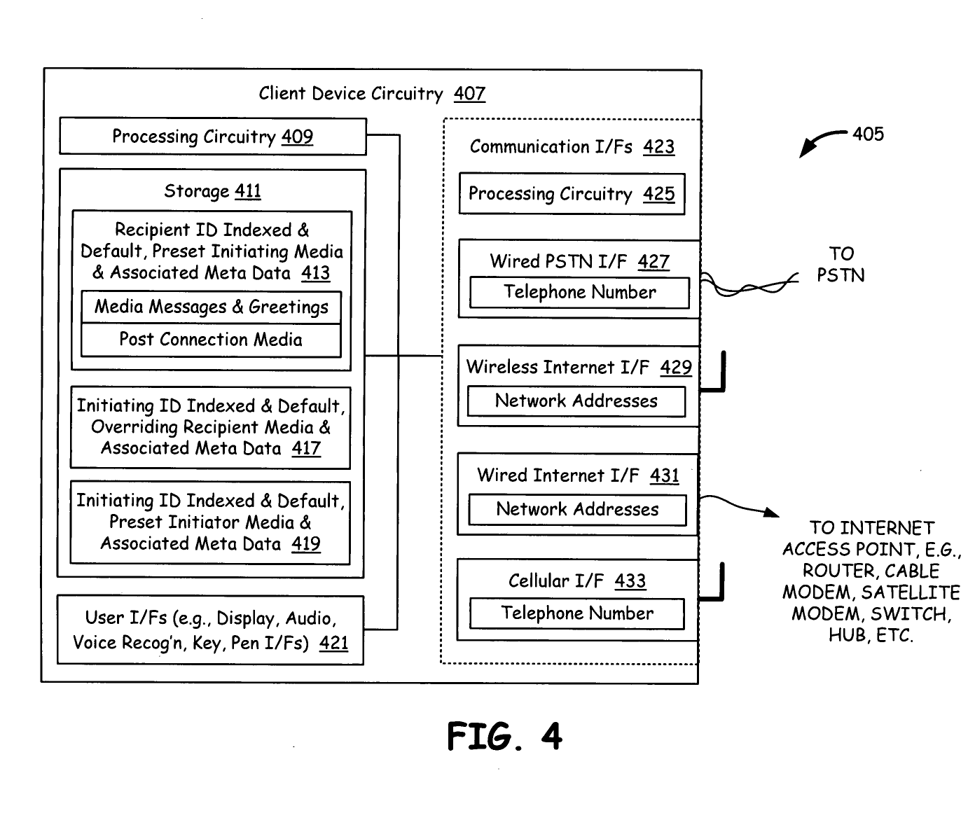

These announcement media (call setup request) are presented in every receiving telephony device (receiving phone, hereafter) 107, 109, 111, 113, 115, 117, or 119 associated with the recipient user. The server utilizes the database entries associated with the recipient user to send a call set up request to all the telephones associated with the recipient user. If a receiving phone is shared by a plurality of users, the announcement media are directed to the intended recipient user only. The receiving phone produces a ring tone for a brief period followed by the announcement media directed to the recipient user, in an attempt to set up a call. Once a call is set up, during the call, a live video of user of the calling telephony device may be presented or alternatively still images sent by the calling telephony device (calling phone, hereafter) 107, 109, 111, 113, 115, 117 or 119 may be presented via the display in user interface (described with reference to the FIG. 4). The receiving phone may also present background music prior to setting up of a call or during the call, initiated by the calling phone, support server 137 or the receiving phone.

The receiving phone 107, 109, 111, 113, 115, 117 or 119 shared by a plurality of users, constructs media messages containing video and audio clips and text messages intended for one of the users based upon call setup information exchanges with the support server 137 and/or the calling phone 107, 109, 111, 113, 115, 117 or 119. The call setup information exchanges may include one or more of: (a) receiving request for a call setup; (b) receiving request for information of the users of the receiving device such as names; (c) sending information of the users to the support server 137 and/or calling device; (d) receiving announcement media tailored for one of the plurality of users; (e) sending greeting reply media in response to the received announcement media; (f) responding to a pickup event by delivering a post connection media; and (g) receiving another post connection media. The respective phones present the post connection media via user interface, once post connection media exchange is completed. Once received, the receiving phone presents announcement media containing live, preset, or prerecorded audio, video clips and text messages to the users of the receiving phone via user interfaces.

For example, a calling user (user of the calling telephony device) decides to communicate (that is, setup a call session) with a recipient user. The calling user may not know the present location of the recipient user and all of the receiving telephony devices associated with the recipient user prior to the call setup. A call setup, according to the call model of the present invention, begins with the calling user entering the Internet Protocol (IP) address of the recipient device either via user interface or through phonebook. The user interface may include voice recognition to accept either the recipient user name or the recipient user IP address. If the calling user does not know the IP address of the recipient user, the calling user may be able to search for such information from a list of users provided by the support server 137 via a web browser like user interface of the calling phone.

Then the user, via display, keypad, voice recognition, video camera (a webcam, for example), and/or microphone interfaces of the user interface, enters options for a series of call setup requests by the calling phone. The series of call setup requests, regarding a call setup with the recipient user, may involve a brief personalized announcement media, importance of the call, brief personalized announcement media to drop in recipient user's voicemail etc. The calling phone may request these entries for these options via one or both of display or speakers and accepts calling user input to these options via a keyboard or microphone. One of these options may include a list of users of the receiving phone and the calling user may enter the intended recipient user option.

For example, the brief personalized announcement media intended for the recipient user may be requested by the calling phone via speakers as “Hello <<calling user>>, please leave <<recipient user>> a brief announcement media after the tone”, where the <<calling user>> and the <<recipient user>> fields are entered via microphone beforehand by the calling user. The calling phone via display may also make the above said request. The calling user captures a brief announcement media via webcam and microphone such as “Hi Recipient User, it is me Calling user, calling about the meeting on Wednesday” or “Hello Recipient User, answer my call regarding an appointment.”

Alternatively, the calling user may preprogram some of these options beforehand and may choose one of the preprogrammed calling format options. Further, the calling user may group the phonebook entries into various categories and may associate a certain preprogrammed calling format options to each of the phonebook entry. A selection of prerecorded brief announcement media of general nature may also be available with the support server 137, which may be activated by the calling phone or may be downloaded by the calling phone for future use. For example, a prerecorded brief announcement media requesting an appointment may be—“Hi, <<calling user>> requests an appointment with <<recipient user>>,” where the <<calling user>> and the <<recipient user>> fields may be available with the database of the calling phone or the support server 137. Similarly for an invitation to a function, the prerecorded brief announcement media may be—“Hi, <<calling user>> invites <<recipient user>> and family on the occasion of <<occasion>> on <<date>> and you area all welcome,” where the <<occasion>> and the <<date>> fields may be entered via microphone beforehand by the calling user. This type of messages may be targeted to a group of people and may be dumped at a preset time in the voicemail boxes of the recipient users.

A typical receiving phone home or a small office environment may include several phones placed in various rooms of the home or office space and the same receiving IP address is used by all these phones and may be shared by a plurality of users such as family members or office co-workers. When a receiving phone receives request for a call setup from a calling phone via support server 137, the receiving phone may receive a request from the support server 137 for the list of users from its database. Alternatively, the support server 137 may request information from the receiving phone's built-in media databases (DB) and media mail storage 121 such as users list periodically and update databases of the support server 137. After initial exchange of user lists of a receiving phone, as a part of call setup, the receiving phone receives a brief announcement media from the calling phone. If the calling phone does not provide a personalized announcement media, the receiving phone constructs such an announcement by exchanging information with the support server 137 or the calling phone.

For example, the receiving phone may receive a fully formed announcement media tailored to a recipient user such as “Hi Recipient User, it is me Calling user, calling about the meeting on Wednesday,” together with a video clip of the calling user and a text message typed by the calling user. If, on the other hand, the receiving phone does not receive a fully formed personalized announcement media, the receiving phone constructs such an announcement by exchanging information with supporting servers 137 or calling phone. For example, the receiver phone may just receive a preset audio message such as “Hi, <<calling user>> requests an appointment with <<recipient user>>,” without entering the fields of calling user and recipient user and/or without a video clip and text message. The receiving phone then requests the support server 137 for information that has not been sent as a part of personalized announcement media such as the fields of calling user and receiving user, or the video clip and text messages.

If such information is not available with the support server 137 or the calling phone, the receiving phone constructs an announcement media based upon received announcement media, information available from the support server 137, and the default settings programmed by the users of the receiving phone. For example, the “Hi, <<calling user>> requests an appointment with <<recipient user>>,” audio message may be replaced by “Hi, user from <<calling IP address>> requests an appointment with Recipient User,” or “Hi, user from <<calling IP address>> requests an appointment with <<recipient user1]>> or <<recipient user2>> or <<recipient user3>>.” Further, if a video clip of the calling user is not available, then a default video clip is presented (a video clip of an unknown calling user, for example). Similarly, a text default message may also be displayed on the screen as a part of announcement media. After completion of construction of a brief announcement media, a ring tone followed by the brief announcement media is presented via user interface. The ring tone may also be personalized to identify the calling phone. If the recipient user is not available to answer the call, the receiving phone may request another media message and the received media message are recorded by the built-in media databases (DB) and media mail storage unit 121.

The receiving phone allows users to program calling user specific announcement media that can be sent to the calling phone as a part of call setup (announcement media response, hereafter). When the receiving phone receives a call setup request from a known calling user, say calling user A, the receiving phone may send a tailored announcement media response. For example, the with audio message as “Hi <<calling user A>>, I am not available right now as I am on vocation, please call after Wednesday,” or “Hi <<calling user A>>, please do not disturb me now, try again later.” If the user has not set any tailored message, the receiving phone constructs an announcement media response based upon information available from the support server 137 and the default settings programmed by the users of the receiving phone. For example, a constructed announcement media response may be “Hi <<calling user A>>, the <<receiving user>> will attend your call, please wait for a while, or try again later.” Some other preset announcement media responses may be available with the support server 137. The users of the receiving phone may download and use these preset announcement media appropriately for a download fee. In addition to the above mentioned options of announcement media responses, the receiving phone user interface provides specific announcement media response options such as Do not disturb, Offline, I am free and Free after <<date/time>>. If the user chooses any of these options, the default announcement media response is constructed based upon a preset announcement that is appropriate. The tailored announcement media responses may override these default messages when a known calling user attempts a call setup.

Regarding the announcement media from unknown callers and sales calls (such as junk or bulk mass media campaign), the receiving phone provides an override facility and block facility that identifies the unknown caller and either presents an overriding announcement media or blocks the user completely from attempting to setup a call. Preset overriding announcement media may be available with the support server 137 or may be captured from the user via user interface. For example, when an unknown caller attempts to call the receiving phone by leaving message such as “Hi <<receiving user>>, this is information regarding a product . . . ,” the receiving phone may override the message by its own announcement media such as “Hi <<receiving user>>, an unknown caller from <<IP address of the caller>> is attempting to contact you.” Alternatively, if the user sets to block these bulk media campaign or any other unknown calls, the receiving phone will block the call and send an announcement media response such as “Hi <<calling user>>, please do not disturb, the <<receiving user>> is not available now.”

FIG. 2 is a block diagram 205 illustrating personalized message, greetings, announcement, and post connection media flow between an initiating client device and a multi-user recipient client device, in a voice communication infrastructure, in accordance with the present invention. In specific, in the voice communication infrastructure, access management software applications 215 manage personalized announcement media access from support servers (137 of FIG. 1) and/or client device databases (121 of FIG. 1). An initiating client device 207 containing preset media messages and preset media greetings initiates an initiation request and/or media greeting 213 via the access management software applications 215 intended for dedicated or multi-user recipient client device(s) 219. Once the initiation request and/or media greeting 213 is initiated by the initiating client device 207, the access management software applications 215 accesses databases of recipient media 221 (in support servers and/or client devices) and communicates initiator and/or recipient announcement media 217 to the dedicated or multi-user recipient client device(s) 219.

Further, the access management software applications 215 communicates connecting/mail media 209 to the initiating client device 207. The dedicated or multi-user recipient client device(s) 219 may further send post connection media 211 to the initiating client device 207, upon pickup. The recipient media 221 consists of initiator ID indexed and default media for initiating device, initiator IDentity (ID) indexed and default media for recipient devices and associated security and access control. The initiator ID indexed and default media for initiating device may further contain databases of media mail greeting and connecting media, and the initiator ID indexed and default media for recipient devices may contain databases of announcement media.

The access management software applications 215 may be centrally located in support servers, or more likely to be distributed between support servers and client devices, with small application programs being deployed in client devices. Similarly, major portions of databases may be located in support servers, with small databases distributed among the client devices.

When the access management software applications 215 receive initiation request and/or media greetings 213 from the initiating client device 207, the access management software applications 215 search through the distributed databases for the dedicated recipient client devices 219 that are associated with the recipient user. Then, the access management software applications 215 provide necessary assistance to the dedicated recipient client devices 219 that are associated with the recipient user to construct announcement media. The recipient media 221 contain databases of media mail greeting and connecting media meant for the initiating device and announcement media meant for recipient devices, which are accessed by the access management software applications 215. The associated security and access control process of the recipient media 221 limit access of the databases of the recipient media by other devices.

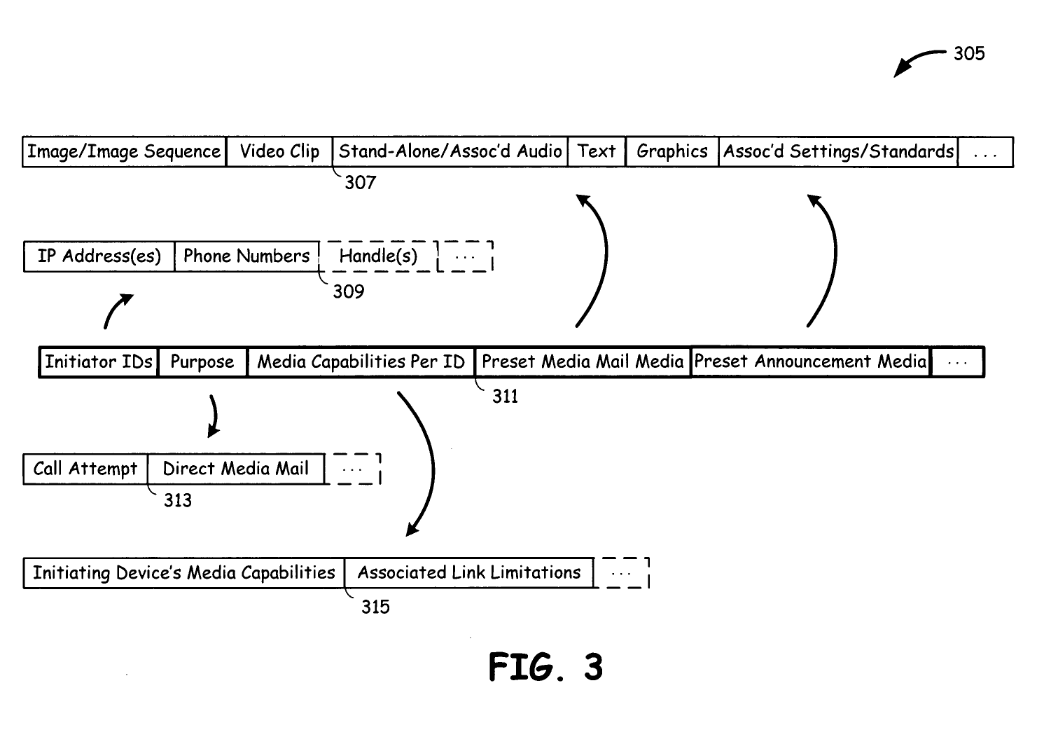

FIG. 3 is a schematic diagram illustrating an embodiment of encapsulation for an announcement media packet 305, in accordance with the present invention. The announcement media packet 311 typically consists of parts such as initiator IDentities (IDs), purpose, media capabilities per ID, preset media mail media, preset announcement media. These parts help a receiving device to construct and present an announcement media as per recipient device settings. These packets may be fully assembled only by the access management software applications (215 in FIG. 2) in the support servers by accessing distributed databases in the support servers and client devices, when initiated by an initiating client device.

The initiator IDs 309 further contains parts such as IP addresses, phone numbers and handles associated with a recipient user. The part purpose 313 further contains parts such as call attempt and direct media mail. Media capabilities per ID 315 contains information regarding the capabilities of the recipient devices such as initiating device's media capabilities and associated link limitations. The preset media mail media and preset announcement media 307 contain actual media mail greetings and the announcement media and has parts such as image/image sequence, video clip, stand-alone/associated audio, text, graphics, associated settings/standards and background music.

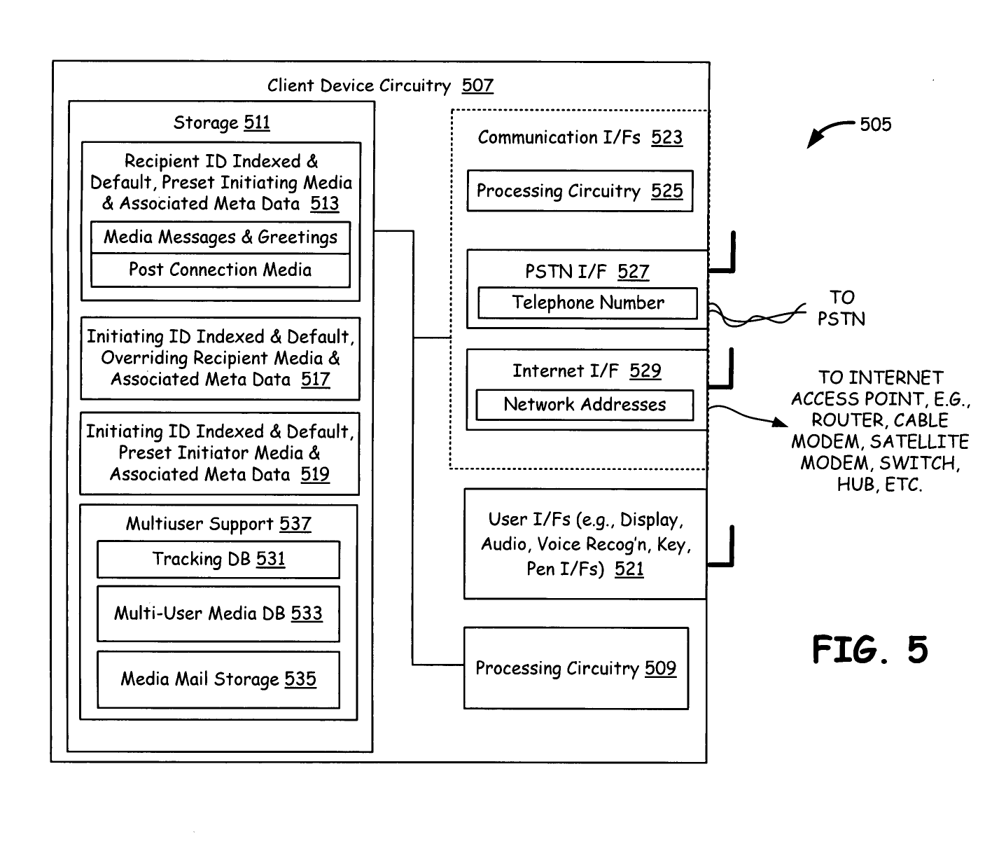

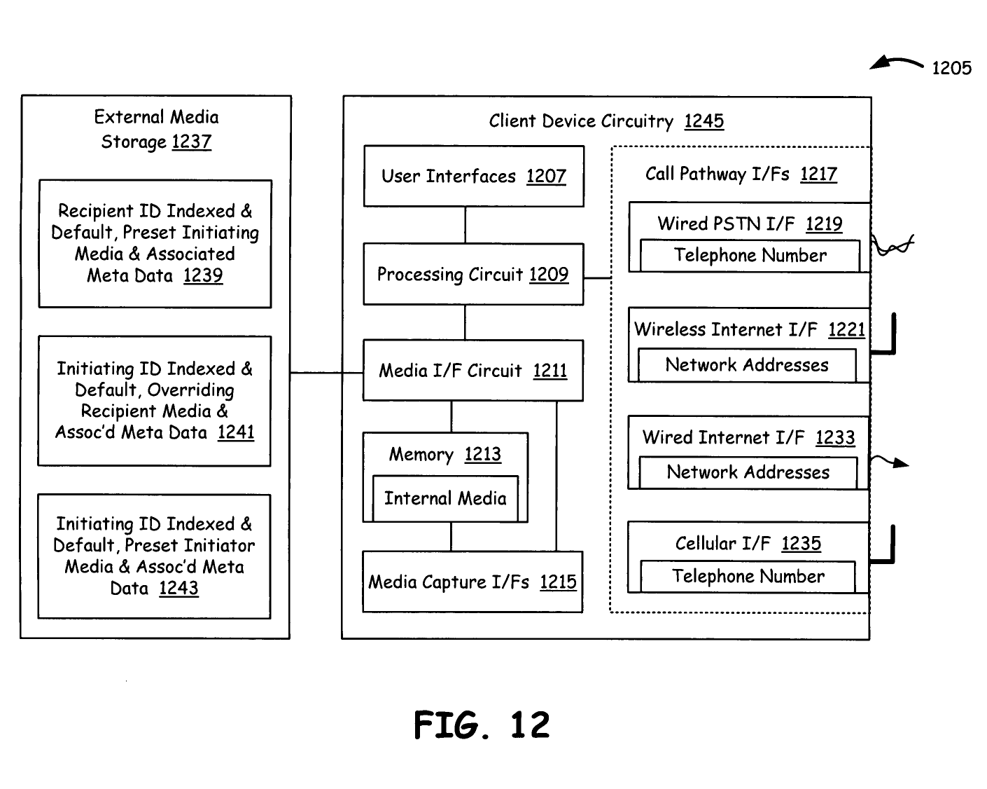

FIG. 4 is a block diagram illustrating a client device 405 constructed in accordance with the embodiment of FIG. 1 of the present invention. The client device 405 illustrated supports wired, wireless, cellular, Internet and public switched telephone network telephony and may correspond at least in part to any of the client devices herein. In other embodiments, the client device 405 of the present invention may include fewer or more components than are illustrated as well as lesser or further functionality, two more embodiments are described with reference to the FIGS. 5 and 12. In other words, the illustrated client devices here and in FIGS. 5 and 12 are meant to merely offer few examples of possible functionality and construction in accordance with the present invention.

A client device circuitry 407 of a client device 405 may be a calling phone or a receiving phone that produces personalized announcements in a shared VoIP network and includes a processing circuitry 409, storage 411, user interfaces 421, and communication interfaces 423. These components communicatively coupled to one another via one or more of a system bus, dedicated communication pathways, or other direct or indirect communication pathways. The processing circuitry 409 may be, in various embodiments, a microprocessor, a digital signal processor, a state machine, an application specific integrated circuit, a field programming gate array, or other processing circuitry. Storage 411 may be random access memory, read-only memory, flash memory, a disk drive, an optical drive, or another type of memory that is operable to store computer instructions and data. A typical announcement media or media greetings may include live, preset, or prerecorded audio, video clips and text messages.

The user interfaces 421 may include a display, video or web camera, audio interfaces, voice recognition, and keypad interfaces. The audio interfaces may include speakers, microphone, and/or a handset, and wireless headset interfaces. Display of the user interfaces 421 may be a conventional LCD display, an LED display, a touch based display, or another display. Wireless headset interface of the user interfaces 421 may be a WPAN interface such as a Bluetooth interface, a proprietary wireless headset interface, or another wireless interface. Handset of the user interfaces 421 enables a user to interact with the components of the bridging telephone and includes a speaker and a microphone. The handset may be movable with respect to the rest of the components of the client device 405. Keypad interface of the user interfaces 421 enables the user to communicate with another client device or support servers via keystroke inputs. In other embodiments, a microphone and a speaker may replace the handset. Such is the case when the voice communication device comprises a wireless telephone.

Communication interfaces 423 includes a wired public (circuit) switched telephone network interface 427, cellular telephone network interface 433, wired Internet interface 431, wireless Internet interface 429 and processing circuitry 423. The wired public switched telephone network interface 427 supports a wired link to public switched telephone networks. The cellular telephone network interface 433 supports a wireless link to cellular networks. The wired Internet interface 431 couples to the packet switched network such as intranet and Internet networks. The wireless Internet interface 429 couples to the packet switched network wirelessly via links such as Wireless Local Area Networks (WLAN). The processing circuitry 425 may exist in communication interfaces 423 as an independent unit as illustrated or may exist as a part of each of the interfaces 427, 429, 431 and 433.

The storage 411 stores application software as well as databases pertaining to the user of the client device 405. The storage 411 contents include recipient ID indexed and default, preset initiating media and associated Metadata 413, initiating ID indexed and default, overriding recipient media and associated Metadata 417 and initiating ID indexed and default, preset initiator media and associated Metadata 419. The recipient ID indexed and default, preset media and associated Metadata 413 consists of data related to media messages and greetings and post connection media.

The user interfaces 421 captures the announcement media, including audio input via microphones and video input via web camera and text messages via voice recognition or keypad interfaces, and allow the processing circuitry to store them in storage 411. Generally, the components of the client device circuitry 407 work to exchange announcement media, media reply greetings, connecting media and post connection media with the support servers and other client devices, and present them via user interfaces 421.

Some of the access management software applications (described with reference to the FIG. 2) may be installed in the client device 405. The processing circuitry, one or both of the processing circuitries 409 and 425, controls the operations interaction with the support servers (described with reference to the FIG. 1) or other client devices. The processing circuitries 409 and 425 execute these instructions to interact with support servers to download announcement media, media reply greetings and post connection media. Further, the processing circuitries 409 and 425, while executing the access management software applications, make entries for the user of the client device 405 and store announcement media, media greetings and post connection media in the storage 411 separately. In addition, the processing circuitries 409 and/or 425 perform information exchange with a recipient client device during a call setup. For example, a call setup information exchanges performed by the processing circuitries 409 and 425 may include one or more of: (a) receiving request for a call setup; (b) receiving request for information of the users of the receiving device such as names; (c) sending information of the users to the support server 137 and/or calling device; (d) receiving announcement media tailored for one of the plurality of users; and (e) sending greeting reply media in response to the received announcement media.

FIG. 5 is a block diagram illustrating a client device 505 constructed in accordance with the embodiment of FIG. 1 of the present invention, with a multi-user support. The client device 505 illustrated supports both public switched and Internet telephony networks. The illustration shows one more embodiment of the client devices of the present invention, but other embodiments may include fewer or more components than are illustrated as well as lesser or further functionality, two more embodiments are described with reference to the FIGS. 4 and 12. In other words, the illustrated client devices here and in FIGS. 5 and 12 are meant to merely offer few examples of possible functionality and construction in accordance with the present invention.

A client device circuitry 507 of a client device 505 includes a processing circuitry 509, storage 51 , user interfaces 521, and communication interfaces 523. These components communicatively coupled to one another via one or more of a system bus, dedicated communication pathways, or other direct or indirect communication pathways. The processing circuitry 509 may be, in various embodiments, a microprocessor, a digital signal processor, a state machine, an application specific integrated circuit, a field programming gate array, or other processing circuitry. Storage 511 may be random access memory, read-only memory, flash memory, a disk drive, an optical drive, or another type of memory that is operable to store computer instructions and data.

The user interfaces 521 may include a display, video or web camera, audio interfaces, voice recognition, and keypad interfaces. The audio interfaces may include speakers, microphone, and/or a handset, and wireless headset interfaces. Display of the user interfaces 521 may be a conventional LCD display, an LED display, a touch based display, or another display. Wireless headset interface of the user interfaces 521 may be a WPAN interface such as a Bluetooth interface, a proprietary wireless headset interface, or another wireless interface. Handset of the user interfaces 521 enables a user to interact with the components of the bridging telephone and includes a speaker and a microphone. The handset may be movable with respect to the rest of the components of the client device 505. Keypad interface of the user interfaces 521 enables the user to communicate with another client device or support servers via keystroke inputs. In other embodiments, a microphone and a speaker may replace the handset. Such is the case when the voice communication device comprises a wireless telephone.

Communication interfaces 523 includes a public (circuit) switched telephone network interface 527, Internet interface 529 and processing circuitry 525. The public switched telephone network interface 527 supports both wired and wireless link to public switched telephone networks. In other words, the public (circuit) switched telephone network interface 527 enables the client device 505 to couple with both traditional PSTN networks and cellular networks. The Internet interface 529 couples to the packet switched network such as intranet and Internet networks, via wired or wireless links. The processing circuitry 525 may exist in communication interfaces 523 as an independent unit as illustrated or may exist as a part of each of the interfaces 527 and 529.

The storage 511 stores application software as well as databases pertaining to each of the users of the client device 505. The storage 511 contents include recipient ID indexed and default, preset initiating media and associated Metadata 513, initiating ID indexed and default, overriding recipient media and associated Metadata 517 and initiating ID indexed and default, preset initiator media and associated Metadata 519. The recipient ID indexed and default, preset media and associated Metadata 513 consists of data related to media messages and greetings and post connection media. Further, the storage 511 consists of database and software related to multi user support 537 such as tracking database 531, multi-user media database 533, and media mail storage 535.

The user interfaces 521 captures the announcement media, including audio input via microphones and video input via web camera and text messages via voice recognition or keypad interfaces and allow the processing circuitry to store them in storage 511 with respective user database in a multi user environment. Generally, the components of the client device circuitry 507 work to exchange announcement media, media greetings, connecting media and post connection media with the support servers and other client devices, and present them via user interfaces 521.

In this embodiment of the client device 505, some of the access management software applications (described with reference to the FIG. 2) are be installed in the client device 505 to provide multi user support. The processing circuitry, one or both of the processing circuitries 509 and 525, controls the operations interaction with the support servers (described with reference to the FIG. 1) or other client devices. The processing circuitries 509 and 525 execute these instructions to interact with support servers to download announcement media, media greetings and post connection media. Further, the processing circuitries 509 and 525, while executing the access management software applications, make separate entries for each of the users who share the client device 505 and store announcement media, media greetings and post connection media in the storage 511 separately. In addition, the processing circuitries 509 and 525 perform information exchange with a recipient client device during a call setup.

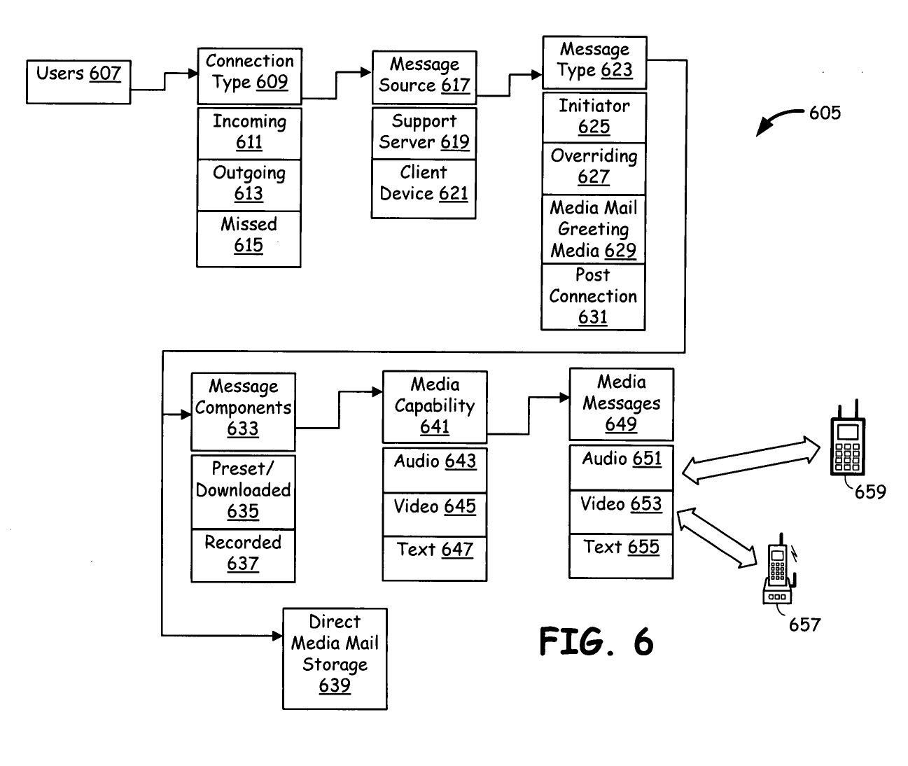

FIG. 6 is a block diagram illustrating database 605 operations performed by access management software applications, located either centrally at a support server or in a distributed manner in the support server and the clients, in a voice communication infrastructure with a plurality of client devices, in accordance with the present invention. The database 605 may be distributed with in the storage of support servers and client devices (described with reference to the FIG. 1) and are accessed by the access management software applications when required. A typical database 605 may contain tables related to users 607, connection type 609, message source 617, message type 623, message components 633, media capability 641 direct media mail storage 639, and media messages 649. However, the tables in the support servers may be far more exhaustive, the illustration of the database 605 shows ones that are more general. The illustration also shows two client devices 659 and 657.

The users table 607 in a support server may contain user names associated with each of the client devices supported by the server and users table in each of the client devices may contain user names who share the client device. Typically, the user table 607 may contain fields of first name, middle name, and last name. The connection type table 609 has 3 parts, incoming 611, outgoing 613, and missed calls 615. This table keeps records of whether a message is incoming, outgoing, or missed, against each of the user names of the user table 607. The message source table 617 has two parts support server 619 and client device 621. This table maintains records of message source, of both received messages and messages sent, that is, against each entry of the connection type table 609.

The message type table 623 maintains records of whether a message received or sent is of initiator type 625, overriding type 627, media mail greeting media type 629, or post connection media type 631. The message components table 633 has two parts, preset downloaded 635 or recorded 637, that is, whether a message is preset downloaded or recorded via user interface. Further, a direct media mail storage table 639 keeps records of messages sent to mail storage. Next, the media capability table 641 keeps records of media capability of each of the client devices associated with users in table 607. The media capability of client devices may be audio 643, video 645, or text 647 presentation capabilities. Finally, media messages table 649 keeps records of all the media messages with separate entries for audio 651, video 653, and text 655.

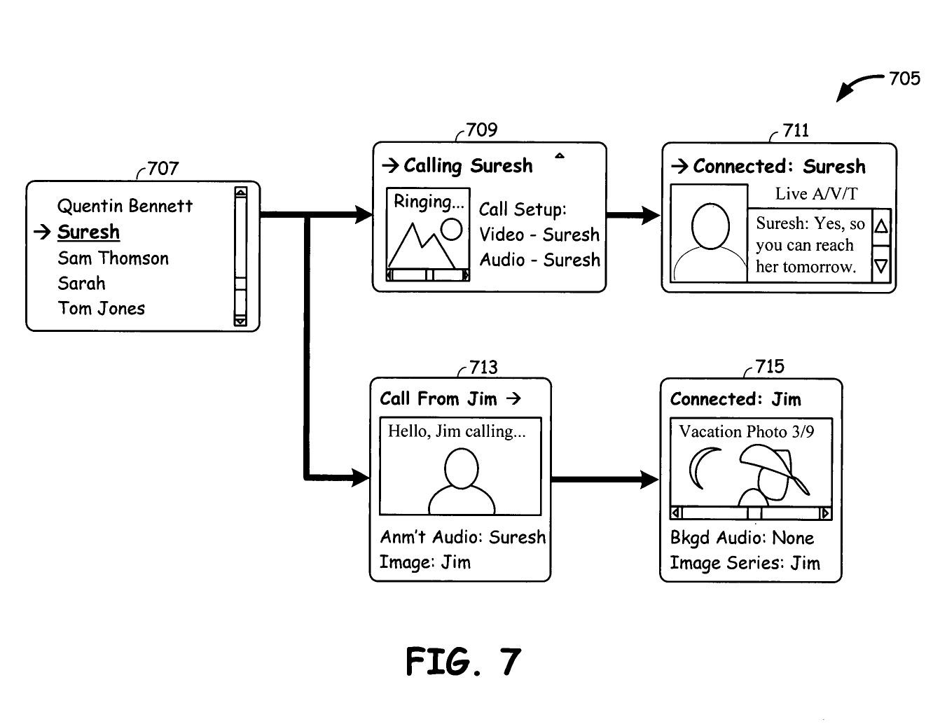

FIG. 7 is a schematic diagram 705 illustrating the process of personalized announcement media exchanges between a calling telephony device and a receiving telephony device, in accordance with the present invention. The schematic diagram illustrates user experience of the call model (described with reference to the FIG. 1), according to the present invention, the calling phone displays 707, 709 and 711 illustrate calling user's experience when a call setup request is made and the displays 713 and 715 illustrate recipient user's experience.

When the calling user attempts to make a call, the calling user may scroll through the phone book and the display in 707 shows a list of entries. The calling user selects a name and initiates a call with the recipient user. The call request is made to all of the phones associated with the recipient via ISP and support servers, the calling phone's display in 709 illustrates the announcement media being sent to the receiving phone(s). Initially when call setup request is made, video display and audio tones are displayed. Further, the calling phone's display in 709 also shows file names of the call setup video and audio messages that are stored either in the storage of calling phone or in the support servers. Later, video, audio, and text messages that are displayed in a receiving phone are simultaneously displayed on the screen of the calling phone during this time. The receiving phone's display in 713 shows the video, audio and text messages being displayed during a call setup. These messages announce a call setup request with the recipient user in all of the phone(s) associated with the recipient user.

Once the recipient user accepts the call, from any one of the associated phones, the calling phone may display live video of the recipient user if available as illustrated in 711, or may simply display a preset or recorded video or image of the recipient user. Similarly, the receiving phone may either display, in 715, a live video of the calling user, or preset video or still images of the calling user depending on availability and phone settings. The calling and receiving phones may also override video images presented during the call with their own video or still images if the phones are set that way.

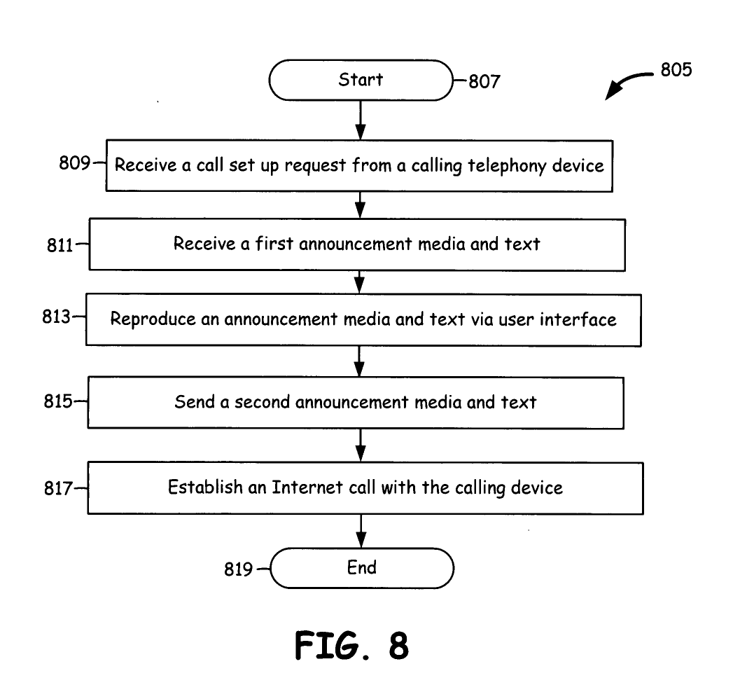

FIG. 8 is a flow diagram 805 illustrating the method performed by a receiving telephony device during a voice communication set up with a calling telephony device. The method starts with block 807, then the receiving phone (receiving telephony device) receives a request from a calling phone (calling telephony device) at a next block 809. At a next block 811, the receiving phone receives a first announcement media and text for presentation in the receiving phone.

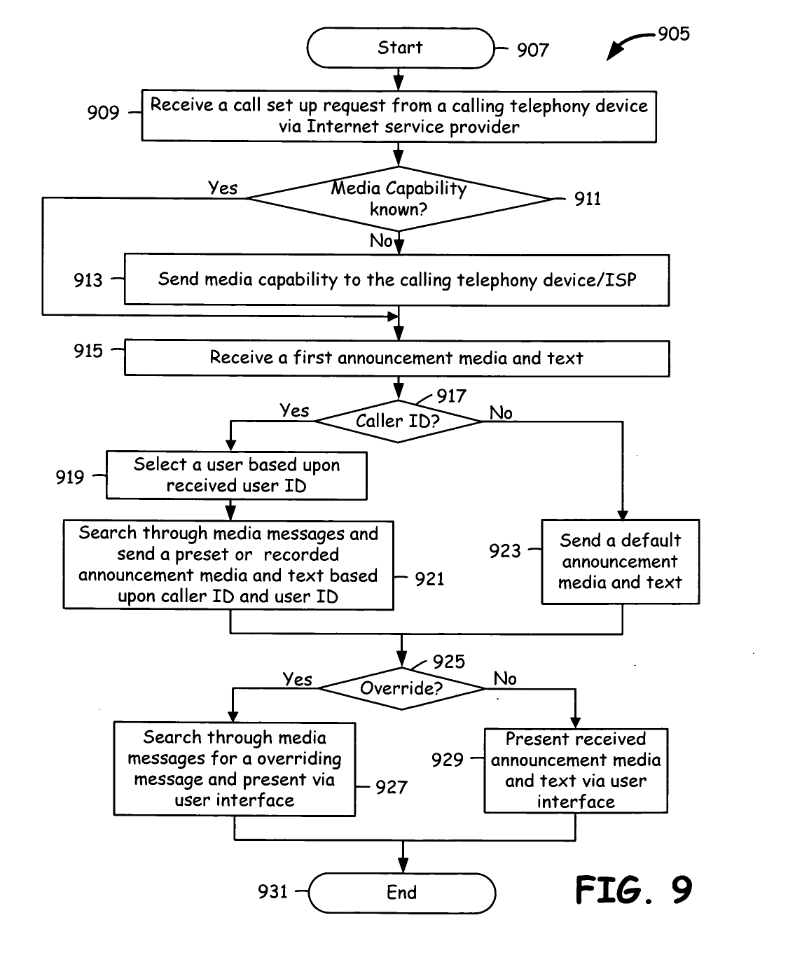

Once received, at a next block 813, the receiving phone presents announcement media containing live, preset, or prerecorded audio, video clips and text messages to the users of the receiving phone via user interfaces. To present the first announcement media initiated by the calling phone via supporting servers, the receiving phone constructs the announcement media based on many considerations. The receiving phone may consider the following steps to construct the announcement media (a detailed discussion on the method involved can be found with reference to the description of FIG. 9): (a) verify user settings regarding request for a call setup, whether the caller ID is in the phone book, or whether the caller is unknown; (b) verify the settings regarding the caller whose caller ID is in the phone book, construct and present announcement media accordingly; (c) if caller is unknown, verify the default settings for unknown callers and construct a override announcement media if necessary and present it.

At a next block 815, the receiving phone sends a second announcement media constructed specifically to the calling user, to the calling phone. The second announcement media may be live, preset or prerecorded audio, video clips and text messages that are constructed according to the settings of the receiving phone to each caller in the phone book, pertaining to each specific situation. The situation may be that of a meeting, emergency, private, official, home related and so on, which are sent to the receiving phone along with the first announcement media. The second announcement media allows the calling user to know the existing situation at the receiving end and the recipient user's intent even before the recipient user actually handling the receiving phone, such as whether the recipient user will accept the call or wants the calling user to call later. At a next block 817, the Internet call is established with the calling phone and the method ends at a next block 819.

FIG. 9 is a flow diagram 905 illustrating the method performed by a receiving telephony device when a call set up request is received from a calling telephony device. The flow diagram 905 illustrates the blocks 809, 811 and 813 of FIG. 8 in detail. The method starts at a block 907, then at a next block 909, the receiving phone receives request for a call setup from a calling phone via ISP and support servers. At a next decision block 911, the receiving phone verifies if the calling phone or the support servers know the media capability of the receiving phone. The media capability may include video, audio and/or text message capabilities. The video capability may further include the capabilities of display such as whether it is a QVGA display or small display such the ones with cellular phones.

At a next block 913, if the media capability is not known, the receiving phone sends media capability to the calling phone or ISP and supports servers. If the calling phone or the support servers already have this information, skips the block of 913. Then at a next block 915, the receiving phone receives announcement media and text messages if any. Then at a next decision block 917, the receiving phone verifies if the calling phone's ID (IP address or telephone number) is in the phone book. At a next block 923, if the caller ID is not available, the receiving phone sends a default announcement media and text, as per user settings, to the calling phone. If the caller ID is available at the decision block 917, at a next block 919, the receiving phone selects the calling user based upon the received ID. Then at a next block 921, the receiving phone searches through the database of media messages for a preset or recorded message as per user settings and sends an announcement media to the calling phone.

Then, at a next decision block 925, the receiving phone determines if the user has set the receiving phone for an overriding message, based upon the user ID of calling user. If no overriding is set for the calling user, at a next block 929, the receiving phone presents received announcement media and text via user interface. If not all of the necessary information are available in the received announcement media for a presentation, the receiving phone interacts with the supporting servers or the calling phone to get such information, or the receiving phone may fix the received announcement media according to a preset rule. For example, if the calling user's name is required but not present in the received preset announcement media, the receiving phone may search through the caller ID list and insert an appropriate name.

If the overriding message setting is enabled at the block 925, the receiving phone, at a next block 927, the receiving phone searches through the media messages for an overriding announcement media, as per user settings, and presents it via user interfaces. The method ends at a next block 931.

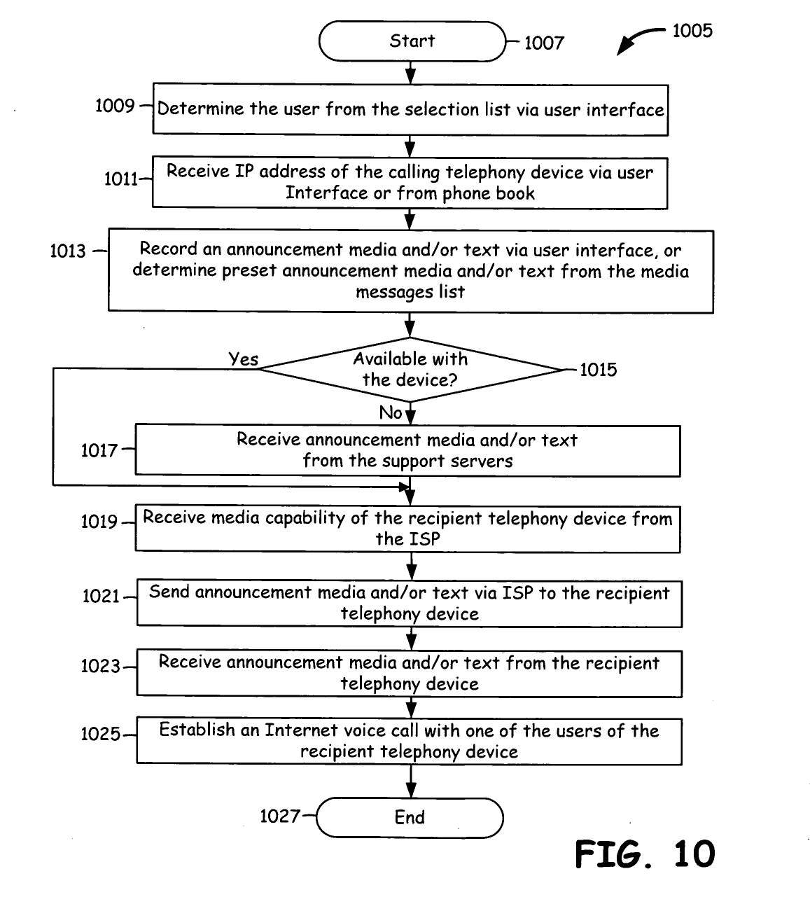

FIG. 10 is a flow diagram 1005 illustrating the method performed by a calling telephony device during a call set up with one of the users of a receiving telephony device shared by a plurality of users. The method starts at a start block 1007 and then at a next block 1009, the calling phone determines the calling user from a selection list via user interface, in a calling telephony device shared by a plurality of users. At a next block 1011, the calling phone receives the name and IP address of the recipient user via user interfaces. In other words, a calling user intending to setup a call with a recipient user either selects the recipient user from the list of users in the phone book or directly enters recipient user's name and IP address via user interfaces.

At a next block 1013, the calling phone captures an announcement media via user interfaces. Alternatively, the user may select a preset or prerecorded announcement media from a list of media messages stored in databases. At a next decision block 1015, the calling phone determines if the selected media message is available with the device. If not available, at a next block 1017, the calling phone downloads preset announcement media from the support servers. If the selected announcement media is available block 1013, the calling phone skips the block 1017.

At a next block 1019, the calling phone interacts with the supports servers and/or the receiving phone and receives media capability of the recipient user's phone. At a next block 1021, the calling phone sends announcement media tailored for the recipient user. At a next block 1023, the calling phone receives one of announcement media tailored for the calling user, a preset or prerecorded announcement media. The calling phone establishes an Internet voice call with the recipient user, at a next block 1025, if the recipient user is accepts the call. The method ends at a next block 1027.

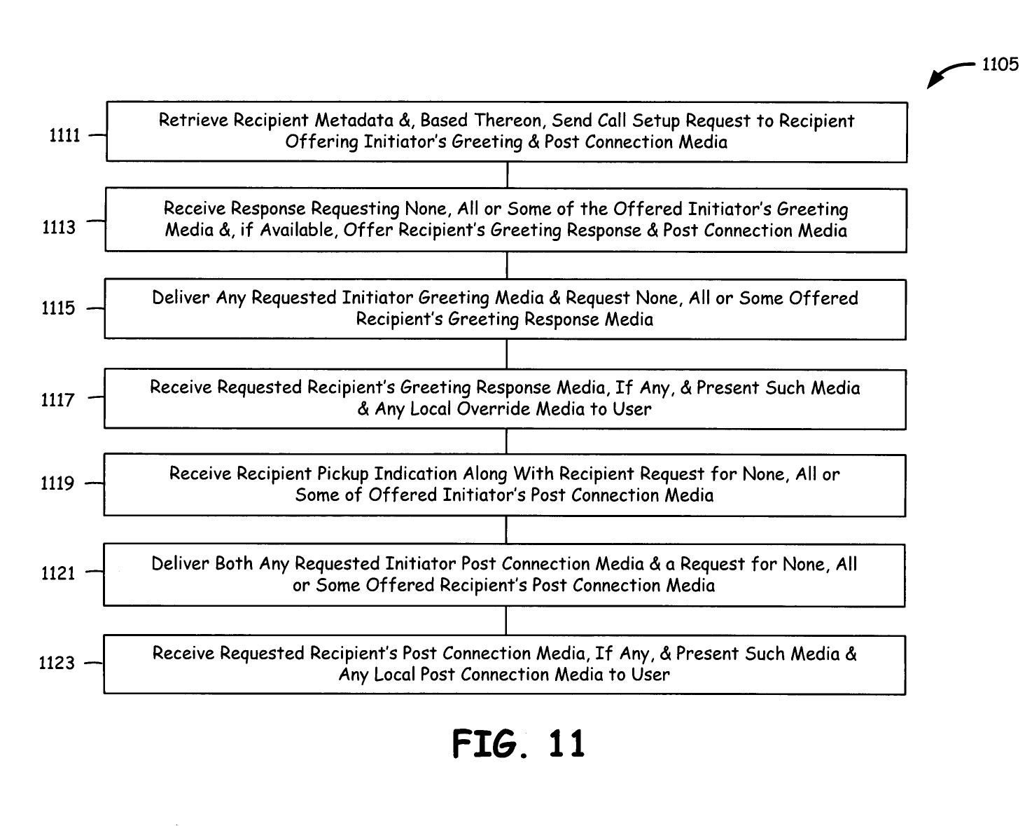

FIG. 11 is a flow diagram 1105 illustrating the method involved in personalized message, greetings, announcement, and post connection media exchange between an initiating client device and a multi-user recipient client device, in accordance with the present invention. The method begins at a block 1111, with an initiating client device retrieving recipient metadata from the database, and then based on this metadata and settings for the recipient the initiating client device sends call setup request to the recipient offering initiator's greeting, and post connection media.

At a next block 1113, the initiating client device receives response requesting none, all or some of the offered initiator's greeting media. The recipient client device may request all of the offered initiator's greeting media if none is available to construct a greeting media, none if all of the elements required to construct greeting media is available. The later may be the case when the recipient client device gets a call setup request from a known caller. Further, the initiating client device may offer recipient's greeting response and post connection media to the initiating device, if available.

At a next block 1115, the initiating client device delivers requested initiator greeting media to the recipient client device. Further, the initiating client device may request none, all or some of the offered recipient's greeting response media. Then at a next block 1117, the initiating client device receives requested recipient's greeting response media. The initiating client device may not request and receive any greeting response media if available locally, and may construct one based upon database message contents. Then the initiating client device presents the received and/or constructed greeting response media. Alternatively, the initiating client device may present an overriding media to the user if such is the setting with the initiating client device.

Then, at a next block 1119, the initiating client device receives recipient pickup indication along with the recipient request for none, all or some of offered initiator's post connection media. Then, at a next block 1121, the initiating client device sends both requested initiator post connection media and a request for none, all or some offered recipient's post connection media. At a next block 1123, the initiating client device receives requested recipient's post connection media and presents such media to the user. Further, the initiating client device may also present any local post connection media to the user.

FIG. 12 is a block diagram illustrating a client device 1205 constructed in accordance with the embodiment of FIG. 1 of the present invention, with details of external storage media. The client device 1205 illustrated supports both public switched and Internet telephony networks. The illustration shows one more embodiment of the client devices of the present invention in addition to the ones illustrated in FIGS. 4 and 5. However, other embodiments may include fewer or more components than are illustrated as well as lesser or further functionality. In other words, the illustrated client devices here and in FIGS. 4 and 5 are meant to merely offer few examples of possible functionality and construction in accordance with the present invention.

A client device circuitry 1245 includes a processing circuitry 1209, memory 1213, user interfaces 1207, media interface circuit 1211, media capture interfaces 1215 and call pathway interfaces 1217. The memory 1213 includes internal media stored in databases. These components communicatively coupled to one another via one or more of a system bus, dedicated communication pathways, or other direct or indirect communication pathways. The processing circuitry 1209 may be, in various embodiments, a microprocessor, a digital signal processor, a state machine, an application specific integrated circuit, a field programming gate array, or other processing circuitry. Memory 1213 may be random access memory, read-only memory, flash memory, a disk drive, an optical drive, or another type of memory that is operable to store computer instructions and data.

The user interfaces 1207 may include a display, video or web camera, audio interfaces, voice recognition, and keypad interfaces. The audio interfaces may include speakers, microphone, and/or a handset, and wireless headset interfaces. Display of the user interfaces 1207 may be a conventional LCD display, an LED display, a touch based display, or another display. Wireless headset interface of the user interfaces 1207 may be a WPAN interface such as a Bluetooth interface, a proprietary wireless headset interface, or another wireless interface. Handset of the user interfaces 1207 enables a user to interact with the components of the bridging telephone and includes a speaker and a microphone. The handset may be movable with respect to the rest of the components of the client device 1205. Keypad interface of the user interfaces 1207 enables the user to communicate with another client device or support servers via keystroke inputs. In other embodiments, a microphone and a speaker may replace the handset. Such is the case when the voice communication device comprises a wireless telephone.

Call pathway interfaces 1217 includes a wired public (circuit) switched telephone network interface 1219, wireless Internet interface 1221, wired Internet interface 1233 and cellular interface 1235. The wired public switched telephone network interface 1219 supports a wired link to public switched telephone networks. The wireless Internet interface 1221 couples to the packet switched network wirelessly via links such as Wireless Local Area Networks (WLAN). The wired Internet interface 1233 couples to the packet switched network such as intranet and Internet networks. The cellular telephone network interface 1235 supports a wireless link to cellular networks. The processing circuitries may exist in call pathway interfaces 1217 as a part of each of the interfaces 1219, 1221, 1233, and 1235.

The media interface circuit 1211 interacts with an external storage media 1237 to send and receive information such as media messages, greetings, and post connection media. The media interface circuit further consists of storage interface circuitry (not shown) that interfaces with the external storage media. The external storage media 1237 may exist anywhere in the voice communication infrastructure, such as with the internet service providers, support servers or other client devices. The storage 1237 contents include recipient ID indexed and default, preset initiating media and associated metadata 1239, initiating ID indexed and default, overriding recipient media and associated metadata 1241 and initiating ID indexed and default, preset initiator media and associated metadata 1243. The recipient ID indexed and default, preset media and associated metadata 1239 consists of data related to media messages and greetings and post connection media. In addition to interfacing with the external media storage 1237, the media interface circuitry 1211 also interfaces with memory 1213 and media capture interfaces 1215 to store captured media in memory 1213 or external media storage 1237.

The media capture interfaces 1215 capture the announcement media, including audio input via microphones and video input via web camera and text messages via voice recognition or keypad interfaces and captured announcement media are stored in memory 1213 for later use. Generally, the components of the client device circuitry 1245 work to exchange announcement media, media greetings, connecting media and post connection media with the support servers and other client devices, and present them via user interfaces 1207.

As one of average skill in the art will appreciate, the term “communicatively coupled”, as may be used herein, includes wireless and wired, direct coupling and indirect coupling via another component, element, circuit, or module. As one of average skill in the art will also appreciate, inferred coupling (i.e., where one element is coupled to another element by inference) includes wireless and wired, direct and indirect coupling between two elements in the same manner as “communicatively coupled”.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A telephone network that processes incoming Internet calls to support a first user and a second user, the telephone network comprising:
an Internet network;
a first receiving telephony device, communicatively coupled to the Internet network, that supports both the first user and the second user;
a second receiving telephony device, communicatively coupled to the Internet network, that supports the first user;
a first calling telephony device, communicatively coupled to the Internet network, that attempts to establish a first Internet call to the first user;
a second calling telephony device, communicatively coupled to the Internet network, that attempts to establish a second Internet call to the second user;
the first receiving telephony device and the second receiving telephony device both respond to the attempt to establish the first Internet call;
the first receiving telephony device responds to the attempt to establish the first Internet call by generating an announcement targeting the first user; and
the first receiving telephony device responds to the attempt to establish the second Internet call by generating an announcement targeting the second user.

2. The telephone network of claim 1 further comprising:
a public switched telephone network;
a third calling telephony device that attempts to establish a voice call to the first user via the public switched telephone network;
the third calling telephony device identifying the first user as part of the attempt to establish the voice call; and
the first receiving telephony device and the second receiving telephony device both respond to the attempt by playing an announcement targeting the first user.

3. The telephone network of claim 1, further comprising storage that contains both an identifier corresponding to the first user and an association of the identifier with the first receiving telephony device and the second receiving telephony device.

4. The telephone network of claim 1, wherein the first receiving telephony device comprises storage that contains an association of the first user with the first receiving telephony device.

5. The telephone network of claim 1, wherein the first calling telephony device comprises storage that contains an association of the first user with the first receiving device.

6. The telephone network of claim 1, further comprising a server, communicatively coupled to the Internet that contains an association of the first user with the first receiving device.

7. The telephone network of claim 6, wherein the server comprises a tracking database.

8. The telephone network of claim 1, wherein the announcement targeting the first user by the first receiving telephony device comprises an audible pick-up request that identifies the first user.

9. The telephone network of claim 1, wherein the attempt to establish the first Internet call to the first user by the first calling telephony device is initiated by a third user and the announcement further identifies the third user.

10. A telephone network that supports calls to both a first user and a second user and from a third user, the telephone network comprising:
an Internet network;
a receiving telephony device, communicatively coupled to the Internet network, that supports the first user and the second user;
a calling telephony device, supporting the third user, that attempts to establish a first call for the third user to the first user via the Internet network; and
the receiving telephony device responds to the attempt to establish the first call by producing a first tailored announcement that targets the first user.

11. The telephone network of claim 10, wherein:
the calling telephony device attempts to establish a second call for the third user to the second user; and
the receiving telephony device responds to the attempt to establish the second call by producing a second tailored announcement that targets the second user.

12. The telephone network of claim 11, further comprising a public switched telephone network, and the attempt to establish the second call by the calling telephony device occurs via a public switched telephone network.

13. The telephone network of claim 10, wherein the first tailored announcement produced by the receiving telephony device comprising an audible announcement that identifies the first user.

14. The telephone network of claim 10, wherein the first tailored announcement targeting the first user by the receiving telephony device comprises a visual image announcement.

15. The telephone network of claim 10, wherein the first tailored announcement targeting the first user by the first receiving telephony device comprises a video announcement.

16. Telephony circuitry, used in a receiving telephony device that is shared by a plurality of users, that receives a call setup request via Internet from a calling telephony device, the telephony circuitry comprising:
an Internet interface circuit that receives the call setup request from the calling telephony device;
a user interface circuit;
processing circuitry communicatively coupled to both the Internet interface and the user interface circuit;
the Internet interface circuit delivers the call setup signal to the processing circuitry;
the processing circuitry uses at least a portion of the call setup signal to identify one of the plurality of users; and
the processing circuitry delivers a tailored announcement that targets the identified one of the plurality of users to the user interface circuit.

17. The telephony circuitry of claim 16, further comprising a media interface circuit, wherein the processing circuit retrieves at least a portion of the tailored announcement via the media interface circuit.

18. The telephony circuitry of claim 17, wherein the media interface circuit comprises a storage interface circuit.

19. The telephony circuitry of claim 17, wherein the media interface circuit comprises a media capture interface circuit.

20. The telephony circuitry of claim 18, wherein the storage interface circuit provides access to a database containing preset announcement media.
